(19) United States
(12) Patent Application Publication
(10) Pub. No.: US 2026/0105523 A1
(43) Pub. Date: Apr. 16, 2026

(54) METHOD AND SYSTEM FOR ADJUSTING ASSET ALLOCATION RATIO

(71) Applicant: CORE16 CO., LTD., Seoul (KR)

(72) Inventor: Yun Nam CHO, Seoul (KR)

(73) Assignee: CORE16 CO., LTD., Seoul (KR)

(21) Appl. No.: 19/049,116

(22) Filed: Feb. 10, 2025

(30) Foreign Application Priority Data
Oct. 14, 2024 (KR) 10-2024-0139374

(51) Int. Cl. G06Q 40/06

(52) U.S. Cl. CPC G06Q 40/06

(57) ABSTRACT

The present disclosure relates to a method and system for adjusting asset allocation ratio, configured to periodically propose the asset allocation ratio for each of the investment target assets to an investor, by inputting investment ratio for two or more investment target assets from an investor, updating the investment ratio for the investment target assets by reflecting investment preferences of the investor, setting target asset values for the investment target assets based on the updated investment ratio, balancing each asset value of the investment target assets to minimize the difference (error) between each of the set target asset values and each asset value of the investment target assets, and adjusting the asset allocation ratio by allocating each investment target asset according to each balanced asset value.

### CROSS REFERENCE TO RELATED APPLICATION

This application claims priority to Korea Patent Application No. 10-2024-0139374 filed on Oct. 14, 2024, the content of which is expressly incorporated by reference in its entirety.

### TECHNICAL FIELD

The present disclosure relates to a method and system for adjusting asset allocation ratio, and more specifically, the method and system are configured to periodically propose the asset allocation ratio for each of the investment target assets to an investor, by inputting investment ratio for two or more investment target assets from an investor, updating the investment ratio for the investment target assets by reflecting investment preferences of the investor, setting target asset values for the investment target assets based on the updated investment ratio, balancing each asset value of the investment target assets to minimize the difference (error) between each of the set target asset values and each asset value of the investment target assets, and adjusting the asset allocation ratio by allocating each investment target asset according to each balanced asset value.

### BACKGROUND

Most people used to invest their assets in at least one of various investment products (investment targets assets), such as stocks, bonds, funds, or real estate, etc.

Such investments are made for various purposes, including economic benefits, long-term financial stability, and retirement planning through growth of assets in the future.

Since various investment products such as stocks, bonds, and funds exhibit a wide range of volatility, risk levels, and growth potential, it is very important to decide how to allocate their assets across such different investment products.

The long-term investment returns are more significantly influenced by how assets are allocated across different investment options rather than the performance of any single investment.

For example, if it is assumed that an investor expects high growth potential, but invests in stocks with high growth potential but high volatility, and bonds which offer relatively lower growth potential but provide stable and predictable returns, the investor can either reduce investment risk or maximize returns through an appropriate adjustment of the asset allocation ratio between stocks and bonds depending on the investment preferences of the investor.

Accordingly, the present disclosure presents a method and system for periodically proposing the asset allocation ratio for each of the investment target assets to an investor, by inputting investment ratio for two or more investment target assets from an investor, updating the investment ratio for the investment target assets by reflecting investment preferences of the investor, setting target asset values for the investment target assets based on the updated investment ratio, balancing each asset value of the investment target assets to minimize the difference (error) between each of the set target asset values and each asset value of the investment target assets, and adjusting the asset allocation ratio by allocating each investment target asset according to each balanced asset value.

Hereinafter, a brief explanation will be provided regarding the prior art existing in the technical field of the present invention, a description of the technical aspects that the present invention aims to achieve things intended to be in differentiated manner compared to the prior art is followed

First, Korean Patent Registration No. 2625533 B1 (16 Jan. 2024) relates to a method and apparatus for determining asset portfolio allocation ratios based on an optimal parameter calculation algorithm. Wherein a first ratio parameter is determined by calculating the return ratio variable corresponding to the asset data for the first time period from the present to the past based on the initial portfolio allocation ratio and asset information, and a second ratio parameter is determined for the optimal period where the return ratio variable is maximized through a greedy search operation while a rolling analysis is performed for each second calculation period corresponding to the asset data within a recent time period based on the initial portfolio allocation ratio and asset information, and then the asset portfolio allocation ratio is determined through the determination of the optimal ratio parameter corresponding to the initial portfolio.

While Korean Patent Registration No. 2625533 B1 discloses a method for determining asset portfolio allocation ratio, but does not involve the suggestion of the present invention of receiving investment ratio for each asset of an investor and setting a target asset value based on the investment preferences of the investor. This prior art also does not disclose a method for adjusting the asset allocation ratio to minimize an error between the set target asset value and the asset value. Therefore, these two inventions have significant differences in their technical configurations, objectives, and effects.

Additionally, Korean Patent Registration No. 2094813 B1 (30 Mar. 2020) relates to method for an asset allocation using financial market instability index. Specifically, this prior art relates to an asset allocation method using a financial market instability index, which makes assets to be optimally distributed by reflecting a risk preference of the investor and as objective reference quantifying the degree of instability in the financial market.

In other words, Korean Patent Registration No. 2094813 B1 only describes a method for allocating assets based on the financial market instability index and a preference of an investor.

In contrast, the present application relates adjusting the asset allocation ratio by allocating each investment target asset according to each balanced asset value, by inputting investment ratio for two or more investment target assets from an investor, updating the investment ratio for the investment target assets by reflecting investment preferences of the investor, setting target asset values for the investment target assets based on the updated investment ratio, and balancing each asset value of the investment target assets to minimize the difference (error) between each of the set target asset values and each asset value of the investment target assets. But Korean Patent Registration No. 2094813 fails to describe, suggest, or imply any of the technical features of the present disclosure.

### BRIEF SUMMARY OF THE EMBODIMENTS

The present disclosure is invented to solve the above-mentioned problems and it is an objective of the present invention to provide a method and system for adjusting an asset allocation ratio that periodically proposes an investor to adjust the asset allocation ratio.

Furthermore, it is another objective of the present invention to provide a method and system that inputs investment ratio for two or more investment target assets and investment preferences of the investor, adjusts the asset allocation ratio according to the investment ratio and investment preferences, and then periodically proposes the asset allocation ratio.

Furthermore, it is another objective of the present invention to provide a method and system that sets target asset values based on the investment ratio reflecting the investment preferences of the investor for the investment target assets, balances each asset value of the investment target assets to minimize the difference between each of the set target asset values and each asset value of the investment target assets, and then adjusts the asset allocation ratio for each of the investment target assets

Furthermore, it is another objective of the present invention to provide a method and system that balances each asset value by firstly adding a result of multiplying the difference by a proportional control coefficient, a result of multiplying a result of integrating the difference over a predetermined period by an integral control coefficient, a result of multiplying a result of the derivative of the difference over the predetermined period by a derivative control coefficient, or a combination thereof, and then reflecting the firstly added result to each of the asset values balanced for the investment target assets at a previous time point.

Furthermore, it is another objective of the present invention to provide a method and system that adjusts the asset allocation ratio by allocating assets based on the balanced asset values and proposing the adjusted asset allocation ratio to the investor.

Furthermore, it is another objective of the present invention to provide a method and system for optimally tuning the proportional control coefficient, integral control coefficient, and derivative control coefficient through the result interpretation and sensitivity analysis for the balanced asset values.

Furthermore, it is another objective of the present invention to provide a method and system for optimally tuning the feedforward control coefficient by using a hypothetical asset return ratio distribution.

It is characterized in that a method for adjusting an asset allocation ratio according to an embodiment of the present invention comprises updating investment ratio for at least two or more investment target assets invested by an investor, at a predetermined time point when the asset allocation ratio is adjusted for the inventor; setting target asset values for asset values of the investment target assets based on the updated investment ratio; balancing the asset values of the investment target assets according to the updated investment ratio, to minimize an error between each of the set target asset values and each of the asset values of the investment target assets; and adjusting the asset allocation ratio by allocating the investment target assets according to the balanced asset values, wherein the investment ratio are updated by reflecting investment preferences of the inventor.

Furthermore, it is characterized in that the updating of the investment ratio includes maintaining the investment ratio previously input by the investor according to the investment preferences for each of the investment target assets, or increasing or decreasing each of the previously input investment ratio with a predetermined ratio (percentage), and the investment preferences include recovery of asset value, receipt of fixed income, receipt of high return, long-term investment, or the combinations thereof.

Furthermore, it is characterized in that the setting of the target asset values includes setting each of the target asset values for asset values of the investment target assets according to the updated investment ratio for asset values of all investment target assets at the predetermined time point.

Furthermore, it is characterized in that the balancing of the asset values includes firstly adding a result of multiplying an error between each of the set target asset values and each of the asset values of the investment target assets by a predetermined proportional control coefficient, a result of multiplying a result of integrating the error over a predetermined period by a predetermined integral control coefficient, a result of multiplying a result of the derivative of the error over the predetermined period by a predetermined derivative control coefficient, or a combination thereof, and then reflecting the firstly added result to each of the asset values balanced for the investment target assets at a previous time point.

Furthermore, it is characterized in that the balancing of the asset values further includes: secondly adding a result of multiplying each of the set target asset values by a predetermined feedforward control coefficient to the firstly added result, and then reflecting the secondly added result to each of the asset values balanced for the investment target assets at a previous time point

Furthermore, it is characterized in that the adjusting of the asset allocation ratio includes firstly tuning the proportional control coefficient, integral control coefficient, derivative control coefficient, or the combinations thereof through a result interpretation and sensitivity analysis on the balanced asset values.

Furthermore, it is characterized in that the adjusting of the asset allocation ratio includes secondly tuning the feedforward control coefficient according to a hypothetical return ratio distribution estimated for each of the investment target assets.

Furthermore, it is characterized in that the firstly tuning includes: tuning the proportional control coefficient, integral control coefficient, derivative control coefficient, or the combinations thereof, so that the error within a predetermined range and the asset values are balanced and output within a predetermined time duration through the result interpretation and sensitivity analysis on the balanced asset values.

Furthermore, it is characterized in that the secondly tuning includes: tuning the feedforward control coefficient by calculating a ratio between the target return ratio set according to the investment preferences of the investor and the estimated return ratio according to the hypothetical return ratio distribution.

Furthermore, it is characterized in that the updating of the investment ratio includes: adding a predetermined rate for annual return ratio of a corresponding investment target asset to each of the previously updated investment ratio, when one of the investment preferences of the investor is the long-term investment.

Furthermore, it is characterized in that the investment target assets are configured to be multiple sectors, each sector includes domestic stocks, foreign stocks, exchange-traded funds, exchange-traded notes, bonds, commodities, real estate, or the combinations thereof, and the asset allocation ratio is adjusted for all sectors, for at least two or more sectors, or for an individual investment target asset that makes up each sector, according to the settings of the investor.

Moreover, it is characterized in that a system for adjusting an asset allocation ratio according to another embodiment of the present invention comprises a memory configured to store a program code for a method for adjusting the asset allocation ratio, and a processor configured to load and execute the program stored in the memory.

As described above, the present invention has the effect of increasing the long-term returns or reducing investment risks of the investor by periodically proposing to adjust the asset allocation ratio to the investor.

Additionally, the present invention has the effect of allowing a portfolio to be constructed according to the investment preferences of the investor, by updating investment ratio based on the preferences of the investor, setting target asset values, balancing the asset values, and adjusting the asset allocation ratio to minimize the difference between the set target asset values and the balanced asset values.

### BRIEF DESCRIPTION OF THE DRAWINGS

FIG. 1 is a diagram illustrating a method and system for adjusting an asset allocation ratio according to an embodiment of the present invention.

FIG. 2 is a diagram illustrating a method for balancing asset values according to an embodiment of the present invention.

FIG. 3 is a diagram illustrating a method of tuning a proportional control coefficient, an integral control coefficient, a derivative control coefficient, and a feedforward control coefficient according to an embodiment of the present invention.

FIG. 4 is a block diagram illustrating a configuration of a system for adjusting an asset allocation ratio according to an embodiment of the present invention.

FIG. 5 is a flowchart illustrating a procedure for balancing an asset allocation ratio according to an embodiment of the present invention.

FIG. 6 is a diagram illustrating a hardware architecture of a system for adjusting an asset allocation ratio according to an embodiment of the present invention.

### DETAILED DESCRIPTION OF THE EXEMPLARY EMBODIMENTS

Hereinafter, preferred embodiments of a method and system for adjusting an asset allocation ratio of the present invention will be described in detail with reference to the accompanying drawings. Identical reference numerals in the drawings indicate the same components. In addition, the specific structural or functional descriptions of the embodiments of the present invention are provided for the purpose of illustrating the embodiments of the present invention, and unless otherwise defined, all terms used herein, including technical or scientific terms, shall have the meanings generally understood by those skilled in the art to which the present invention pertains. Terms that are commonly used and defined in dictionaries should be interpreted in accordance with their meanings in the context of the relevant technology, and unless explicitly defined in this specification, should not be interpreted in an idealized or excessively formal manner.

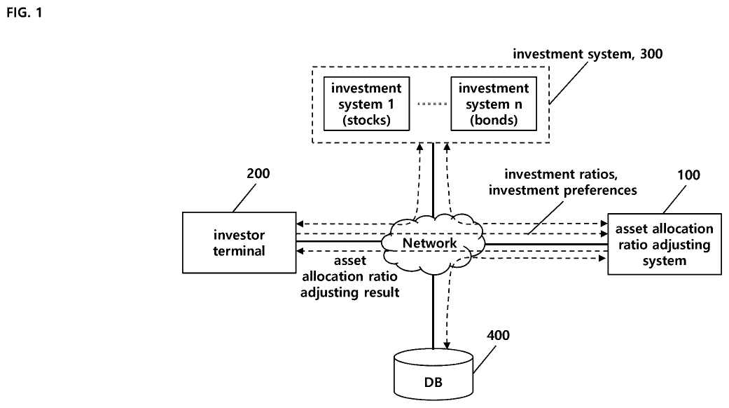

FIG. 1 is a diagram illustrating a method and system for adjusting an asset allocation ratio according to an embodiment of the present invention.

As shown in FIG. 1, a system for adjusting an asset allocation ratio (hereafter refer to an asset allocation ratio adjusting system) 100 according to an embodiment of the present invention is configured to be inputted investment ratio and investment preferences for at least two investment target assets from an investor terminal 200, update the investment ratio according to the input investment preferences of the investor, set target asset values for asset values of the investment target assets, balance the asset values of the investment target assets, periodically adjusts the asset allocation ratio, and thereby transmit the result of the adjusted asset allocation ratio to the investor terminal 200 to propose the adjusted asset allocation ratio to the investor.

The investor terminal 200 refers to a wired or wireless communication terminal (e.g., a smartphone) used by an investor who has made investments in at least two investment target assets.

The investor can periodically receive a proposal of the asset allocation ratio adjustment results by downloading and running an application program (app) to receive the asset allocation ratio adjustment results from the asset allocation ratio adjusting system 100.

The investment target assets consist of multiple sectors, each sector comprises domestic stocks, foreign stocks, exchange-traded funds (ETFs), exchange-traded notes (ETNs), bonds, commodities, real estate, or the combinations thereof. Additionally, each sector is composed of multiple assets.

The investment target assets in which the investor has invested constitute an investment portfolio, and the investment ratio refers to a ratio how much fund (cash) the investor invests to each of the investment target assets within the investment portfolio.

For example, if an investor invests 60 million dollars in stocks and 40 million dollars in bonds out of a total of 100 million dollars in cash, the investment ratio would be 6:4 (60%:40%).

Additionally, the asset allocation ratio adjusting system 100 is configured to update the investment ratio according to investment preferences of the investor.

The investment preferences of the investor include asset value restoration or receipt of fixed return ratio for the investment target assets (Case 1), return ratio prioritization (i.e., high return reception) (Case 2), long-term investment for a predetermined period exceeding a certain duration (Case 3), or the combinations thereof. However, the cases are not limited to the above and various types of investment preferences can be further defined in the present invention.

For example, the investment preference corresponding to Case 1 (asset value restoration or receipt of fixed return ratio for the investment target assets) refers to an approach where an investor aims to achieve fixed returns (e.g., dividends from stocks) even when the price of the investment target assets plummets due to various causes such as financial crises or disasters (e.g., the outbreak of a pandemic).

As another example, Case 2 (return ratio prioritization), refers to an approach of achieving high returns, and Case 3 (long-term investment) refers to an approach of achieving returns through long-term investments for a predetermined period exceeding a specific duration. The investment preferences can be changed through the investor terminal 200 by the investor.

The asset allocation ratio adjusting system 100 is configured to update an investment ratio for each investment target asset based on the investment preferences of the investor and set each target asset value of the investment target assets according to the updated investment ratio.

For example, if the investment ratio for stocks over total investment target assets is 0.5 (i.e., 50%) and the investment ratio is updated to be 100% (i.e., maintained as is) according to the investment preference of the investor, the target asset value is set for the investment ratio 50%.

The updating of the investment ratio may vary depending on the investment preferences of the investor. If one of the investment preferences corresponds to Case 1, the investment ratio may be updated to be 100%; if one of the investment preferences corresponds to Case 2, the investment ratio may be updated to be 130%; and if one of the investment preferences corresponds to Case 3, the investment ratio may be updated at predetermined long-term investment intervals.

In the end, the investment ratio is updated either by maintaining the investment ratio input by the investor according to the investment preferences of the investor, or by increasing or decreasing the investment ratio by a predetermined percentage.

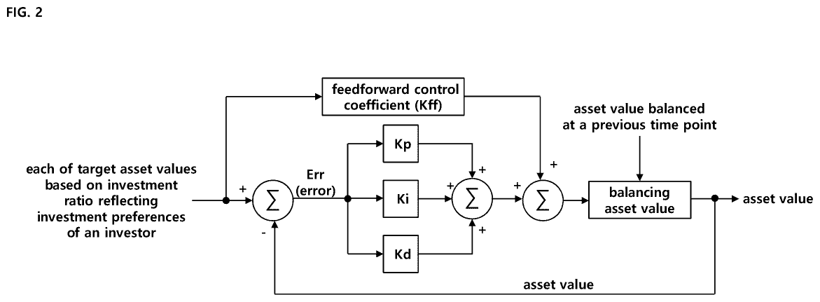

The setting of the target asset value is explained in detail with reference to FIG. 2.

Furthermore, the asset allocation ratio adjusting system 100 is configured to balance the asset value of each investment target asset based on the overall asset value of each investment target asset and the updated investment ratio.

The balancing of the asset value of the investment target asset according to the updated investment ratio is performed to minimize the difference between the actual asset value of the investment target asset and the target asset value, and the adjusting of an asset allocation ratio for each investment target asset is performed by reflecting the asset value balanced at a previous time point.

To balance the asset value of the investment target asset, the asset allocation ratio adjusting system 100 is configured to request the actual asset value for each investment target asset to the investment system 300, and acquire the actual asset value from the investment system 300 in real-time.

To this end, the asset allocation ratio adjusting system 100 is configured to be interworked with each investment system 300 by obtaining agreement from the investor, so that the asset value for each investment target asset is shared from each investment system 300 to the asset allocation ratio adjusting system 100.

For example, if an investor invests in stocks listed on the Korean stock market, the asset allocation ratio adjusting system 100 is configured to obtain agreement from the investor to interwork with the investment system (i.e., a security server) 300 used to invest in Korean stocks. The asset allocation ratio adjusting system 100 is configured to obtain agreement integrated across all investment systems 300.

Here, the investment system 300 refers to various kinds of investment platform including a security server (platform) for investing in domestic stocks, overseas stocks, exchange-traded funds (ETFs), exchange-traded notes (ETNs), or bonds (including government bonds), a real estate investment system (platform) for investing in real estate, or an investment system (platform) for investing in commodities.

The asset allocation ratio adjusting system 100 is configured to balance the asset value by using an error between each set target asset value and each of the asset values of the investment target assets, the previously balanced asset value, the proportional control coefficient for the error, the integral control coefficient for the error, the derivative control coefficient for the error, the feedforward control coefficient for balancing a ratio for the asset value, or the combinations thereof.

The setting of the target asset value and the balancing of the asset value are explained in detail with reference to FIG. 2.

Additionally, the asset allocation ratio adjusting system 100 is configured to adjust the asset allocation ratio based on the balanced asset value and transmit the adjusted asset allocation ratio to the investor terminal 200.

FIG. 2 is a diagram illustrating a method for balancing asset values according to an embodiment of the present invention.

As shown in FIG. 2, the asset allocation ratio adjusting system 100 according to an embodiment of the present invention is configured to balance the asset value to minimize the error between the target asset value according to the changed investment ratio and the actual asset value.

The asset value is balanced by the following [Equation 1].

$$Asset {Value}_{t} = ( [ Kp \cdot Err + Ki \int Errdt + Kd \frac{dErr}{dt} ] + Kff + Asset {Value}_{t - 1} ) \qquad [ Equation 1 ]$$

$$Wherein , Err = TargetAssetValue - AssetValue$$

Wherein, AssetValueₜ refers to an asset value of the investment target asset balanced at a specific time point (or the current time t), and Kp, Ki, and Kd refer to a proportional control coefficient, an integral control coefficient, and a derivative control coefficient, respectively, and Kff refers to a feedforward control coefficient. Additionally, AssetValueₜ₋₁ refers to the balanced asset value at a previous time point (t−1), and TargetAssetValue refers to a target asset value based on the investment ratio updated by reflecting investment preferences of an investor.

The asset allocation ratio adjusting system 100 is configured to balance an asset value of each of the investment target assets by optimally tuning a proportional control coefficient, an integral control coefficient, and a derivative control coefficient, with a feedback on the balanced asset value, to minimize the difference between the target asset value and the actual asset value, or further optimally tuning a feedforward control coefficient, and thus finally balancing the asset value of each of the investment target assets.

Moreover, the asset allocation ratio adjusting system 100 can be configured to finally balance the asset value by optimally tuning the proportional control coefficient, the integral control coefficient, the derivative control coefficient, or the combinations thereof, with a feedback on the balanced asset value, to minimize the difference between the target asset value and the actual asset value. Or alternatively, the feedforward control coefficient can be included to optimize the tuning and finally the asset value can be balanced. That is, it is not necessary to always include the feedforward control coefficient.

That is, the asset value balanced at a time point t (e.g., the current time) is obtained by using the optimally tuned proportional control coefficient, the integral control coefficient, the derivative control coefficient, the feedforward control coefficient, or the combinations thereof.

It is preferable for these proportional control coefficient, integral control coefficient, derivative control coefficient, and feedforward control coefficient to be optimally tuned in real-time. However, the tuning is not limited to real-time, and the coefficients may be tuned periodically as well.

The proportional control coefficient, integral control coefficient, and derivative control coefficient are tuned through result interpretation and sensitivity analysis, and the feedforward control coefficient is tuned by using a hypothetical return ratio distribution.

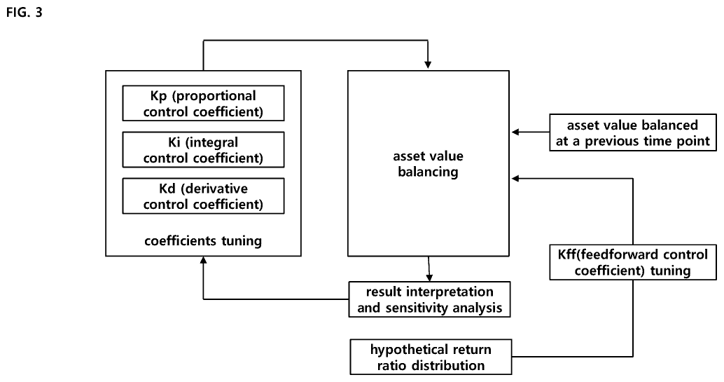

The tuning of the proportional control coefficient, integral control coefficient, derivative control coefficient, feedforward control coefficient, or the combinations thereof is explained in detail with reference to FIG. 3.

FIG. 3 is a diagram illustrating a method of tuning a proportional control coefficient, an integral control coefficient, a derivative control coefficient, and a feedforward control coefficient according to an embodiment of the present invention.

As shown in FIG. 3, the asset allocation ratio adjusting system 100 according to an embodiment of the present invention is configured to optimally tune the proportional control coefficient, integral control coefficient, derivative control coefficient, feedforward control coefficient, or the combinations thereof, and balance the asset value of each investment target asset for adjusting asset allocation ratio using [Equation 1].

[Equation 1] shows the balancing of the asset value for adjusting asset allocation ratio by considering all of Kp, Ki, Kd, and Kff. However, it is also acceptable to balance the asset value for adjusting asset allocation ratio using Kp, Ki, Kd, Kff, or any combination thereof.

The proportional control coefficient is related to a response to an error at current time position. The larger the proportional control coefficient, the faster the system reacts to the error and reaches the target asset value, but it may result in an overshoot, an oscillation, or a slower response time.

The integral control coefficient is used to accumulate past errors and correct persistent errors. The larger the integral control coefficient, the more effective in eliminating small errors, but if the integral control coefficient is too large, an oscillation or overshoot may occur.

The derivative control coefficient is used to suppress an oscillation by mitigating the change in error based on the change rate of the error. If the derivative control coefficient is too big, the response speed may slow down. If the derivative control coefficient is too small, the effectiveness of suppressing the oscillation is decreased.

Therefore, the asset allocation ratio adjusting system 100 is configured to analyze the interactions among the proportional control coefficient, the integral control coefficient, the derivative control coefficient, or the combinations thereof, to maintain the error within a specified range and output the stably balanced asset value within a predetermined time, through the result interpretation and sensitivity analysis of the balanced asset value.

The proportional control coefficient, integral control coefficient, and derivative control coefficient can be tuned by the Ziegler-Bichols tuning method or the Cohen-Coon tuning method.

The Ziegler-Bichols tuning method and the Cohen-Coon tuning method are primarily used in PID control, which is applied in industrial process control techniques. Thus, a detailed explanation of them is omitted.

Additionally, the asset allocation ratio adjusting system 100 is configured to tune a feedforward coefficient based on a hypothetical return ratio distribution that mathematically modeled for each investment target asset that the investor has invested in. Herein, the feedforward control coefficient is used to determine the investment amount or asset allocation ratio required for achieving a target return ratio.

The hypothetical return distribution is generated by testing various situations through simulations and assuming how the return is changed accordingly, and it can be provided by each investment system 300. However, it is not limited to be generated by each investment system 300, but can also be generated within the asset allocation ratio adjusting system 100 according to the present invention. The hypothetical return ratio distribution can be periodically updated.

The asset allocation ratio adjusting system 100 is configured to calculate the expected return ratio by using statistical indicators (standard deviation, variance, skewness, etc.) including an average extracted from the hypothetical return ratio distribution, and tune the feedforward control coefficient by calculating capital investment quantity or asset ratio required for achieving the target return ratio.

The feedforward coefficient is tuned by ‘target return ratio/expected return ratio’ at the current time point t.

Therefore, the asset allocation ratio adjusting system 100 is configured to set the target return ratio based on investment preferences of the investor and tune the feedforward control coefficient accordingly.

Since the hypothetical return ratio distribution continuously fluctuates according to market changes, it is preferable for the feedforward coefficient to be balanced in real time.

That is, the feedforward control coefficient is optimally tuned through the hypothetical return ratio distribution, target return ratio, and expected return ratio.

On the other hand, if an investor has invested in domestic (i.e., Korea) stocks, overseas stocks, and bonds with an investment ratio of 5:3:2, the asset values at time point t are balanced through the example of Case 1, and the asset values for domestic stocks, overseas stocks, and bonds at the previous time point (t−1) are assumed to be 5 million KRW, 3 million KRW, and 2 million KRW respectively, the asset allocation ratio adjusting system 100 is configured to update the investment ratio for domestic stocks to 100% at time point (t−1) (i.e., 0.5 (i.e., 50%) of the total investment ratio), and balance the target asset value to 5 million KRW.

Subsequently, assuming that the asset values of other investment target assets remain the same, and the price of the domestic stocks increases and the asset value of the domestic stocks raises to 10 million KRW, at a time point t, the investment ratio for the domestic stocks increases to approximately 66.7%, while the investment ratio for overseas stocks and bonds decrease to approximately 20% and 13.3%, respectively.

Therefore, the asset allocation ratio adjusting system 100 is configured to update the investment ratio of domestic stocks to 50% (0.5) based on the investment ratio input by the investor, and balance the asset value of domestic stocks to minimize the difference (i.e., error) between the target asset value corresponding to the updated investment ratio of domestic stocks (50% of total 15 million KRW (=10+3+2)=7.5 million KRW) and the asset value of domestic stocks.

The unit for the asset value varies depending on the country. For example, for Korean stocks, the unit is KRW, and for U.S. stocks, the unit is USD.

In this case, the asset allocation ratio adjusting system 100 is configured to balance the asset value of domestic stocks according to the updated investment ratio at time point t, by using the proportional control coefficient, integral control coefficient, derivative control coefficient, feedforward control coefficient, or the combinations thereof, and the asset value of domestic stocks balanced at the previous time point t−1, as explained with reference to FIG. 2.

If assuming an extreme case where the error is 0, the balanced asset value of domestic stocks becomes 7.5 million KRW.

In this case, the asset allocation ratio adjusting system 100 is configured to propose to the investor to adjust the asset allocation ratio by allocating the 2.5 million KRW, which is the difference between the actual asset value of 10 million KRW in domestic stocks and the balanced asset value of 7.5 million KRW, to overseas stocks and bonds (i.e., 1.5 million KRW to overseas stocks and 1 million KRW to bonds).

As another example, assuming the investor has invested in domestic stocks, overseas stocks, and bonds with an asset allocation ratio of 5:3:2, and the asset values of domestic stocks, overseas stocks, and bonds at the previous time point t−1 are 5 million KRW, 3 million KRW, and 2 million KRW, respectively, and the investment preference of the investor for domestic stocks is Case 2, then the asset allocation ratio adjusting system 100 is configured to update the investment ratio of domestic stocks to 120% (i.e., 60% of the total investment allocation ratio), and balance the target asset value to 7.8 million KRW.

Subsequently, assuming that the asset values of other investment target assets remain the same at time point t, and the price of domestic stocks increases, the asset value of domestic stocks is made to 10 million KRW, then the investment ratio of domestic stocks increases to approximately 66.7% of the total investment allocation ratio (15 million KRW), while the investment ratio of overseas stocks and bonds decrease to approximately 20% and 13.3%, respectively.

Therefore, the asset allocation ratio adjusting system 100 is configured to update the investment ratio of domestic stocks to 60% (0.6) of the total asset value according to the investment ratio input by the investor, and balance the asset value of domestic stocks to minimize the difference (error) between the target asset value (60% of 15 million KRW (=10+3+2)=9 million KRW) according to the balanced investment ratio of domestic stocks and the asset value of domestic stocks.

The asset allocation ratio adjusting system 100 is configured to balance the asset value of domestic stocks according to the investment ratio updated at time point t, by using the proportional control coefficient, integral control coefficient, derivative control coefficient, feedforward control coefficient, or the combinations thereof, and the asset value of domestic stocks balanced at the previous time point t−1, as described with reference to FIG. 2.

If assuming the error is zero as an extreme case, the balanced asset value of the domestic stocks becomes 9 million KRW.

In this case, the asset allocation ratio adjusting system 100 is configured to propose to the investor to adjust the asset allocation ratio by allocating 1 million KRW, which is the difference between the actual asset value of domestic stocks (10 million KRW) and the balanced asset value (9 million KRW), to U.S. stocks and bonds (i.e., 0.6 million KRW to U.S. stocks and 0.4 million KRW to bonds) according to the investment ratio. In Case 2, since the investment ratio in domestic stocks increases, the investment ratio in the other investment target assets, such as U.S. stocks and bonds, relatively reduces.

As another example, assuming that an investor invests in domestic stocks, foreign stocks, and bonds with an investment ratio of 5:3:2, and the asset values of domestic stocks, foreign stocks, and bonds at a previous time point t−1 are 5 million KRW, 3 million KRW, and 2 million KRW, respectively, and the investment preference of the investor for domestic stocks is Case 3, then the asset allocation ratio adjusting system 100 is configured to update the investment ratio for domestic stocks according to [Equation 2].

$${SET\_POINT}_{t} = {SET\_POINT}_{t - 1} \times ( 1 + 0.2 / 52 w ) \qquad [ Equation 2 ]$$

Wherein, SET_POINT refers to the investment ratio updated for the input investment ratio of a specific investment target asset in the overall asset value. The updated investment ratio refers to the investment ratio that is increased or decreased with some percentage compared to the input investment ratio.

In Case 3, the investment ratio is updated by multiplying the previously updated investment ratio for a specific investment target asset by a predetermined percentage (0.2/52 w) for a predetermined annual return ratio for a specific investment target asset, and then adding the previously updated investment ratio to the multiplied result. Here, since one year corresponds to 52 weeks, w is equal to a week (=7 days).

Subsequently, the asset value of domestic stocks is balanced to minimize the difference (error) between the target asset value based on the updated investment ratio according to the [Equation 2] at time point t and the asset value of domestic stocks.

In this case, the asset allocation ratio adjusting system 100 is configured to balance the asset value of domestic stocks according to the updated investment ratio at time point t by using the proportional control coefficient, integral control coefficient, differential control coefficient, feedforward control coefficient, or the combinations thereof, and the asset value of domestic stocks balanced at the previous time point t−1, as explained with reference to FIG. 2, adjust an asset allocation ratio for domestic stocks, U.S. stocks, and bonds, and propose the asset allocation ratio to the investor.

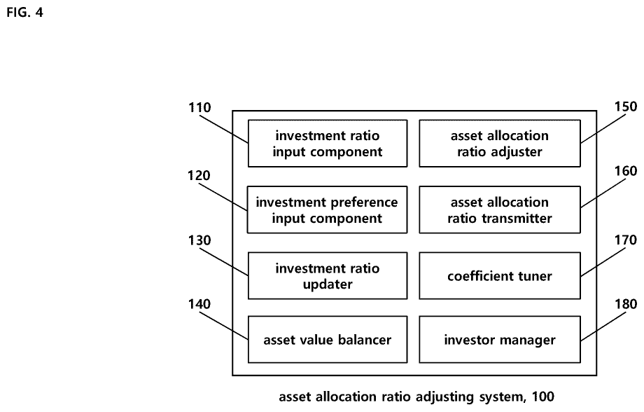

FIG. 4 is a block diagram illustrating a configuration of a system for adjusting an asset allocation ratio according to an embodiment of the present invention.

As shown in FIG. 4, the asset allocation ratio adjusting system 100 according to one embodiment of the present invention is for periodically proposing the asset allocation ratios to the investor, and comprises an investment ratio input component 110, an investment preference input component 120, an investment ratio updater 130, an asset value balancer 140, an asset allocation ratio adjuster 150, an asset allocation ratio transmitter 160, a coefficient tuner 170, and an investor manager 180.

The investment ratio input component 110 is configured to receive an investment ratio inputted for at least two or more investment target assets from the investor through the investor terminal 200. Wherein, the investment ratio refers to an initial investment ratio. Therefore, the investment ratio inputted through the investment ratio input component 110 is assigned as the initial investment ratio for each designated variable indicating the investment target assets in a software or hardware module constituting the asset allocation ratio adjusting system 100 according to the present invention.

The investment preference input component 120 is configured to receive investment preferences of the investor for each investment target asset through the investor terminal 200. Each of the investment preferences inputted through the investment preference input component 120 is assigned as the investment preference for each designated variable indicating each investor in the software or hardware module constituting the asset allocation ratio adjusting system 100 according to the present invention.

The investment ratio updater 130 is configured to update the investment ratio according to the investment preferences of the investor, and set the overall actual asset values for all investment target assets and the target asset values based on the updated investment ratio, respectively.

The investment ratio is updated individually for each investment target asset based on the investment preference for each investment target asset, and the target asset values are set individually for each investment target asset according to the updated investment ratio for each investment target asset.

The actual asset value of an investor can be collected from the investment system 300 for each investment target asset.

Moreover, the asset allocation ratio adjusting system 100 of the present invention is configured to interwork with each separately implemented investment system 300 to adjust the asset allocation ratio. However, the asset allocation ratio adjusting system 100 is not limited to the aforementioned configuration, and it is also possible for the asset allocation ratio adjusting system 100 to be integrated and configured as a part of the investment system 300, or alternatively integrated and configured in the opposite way.

Since the updating of the investment ratio and the setting of the target asset value are explained with reference to FIG. 2 and FIG. 3, so they are omitted herein.

The asset value balancer 140 is configured to balance the asset value according to the updated investment ratio to minimize the error between the target asset value set based on the updated investment ratio and the actual asset value.

The asset value balancer 140 is configured to balance the asset value for each investment target asset by firstly adding a result of multiplying an error between each of the set target asset values and each of the asset values of the investment target assets by a predetermined proportional control coefficient, a result of multiplying a result of integrating the error over a predetermined period by a predetermined integral control coefficient, a result of multiplying a result of the derivative of the error over the predetermined period by a predetermined derivative control coefficient, or a combination thereof, and then reflecting the firstly added result to each of the asset values balanced for the investment target assets at a previous time point. The asset value balancer 140 is further configured to balance the asset value for each investment target asset by secondly adding a result of multiplying each of the set target asset values by a predetermined feedforward control coefficient to the firstly added result, and then reflecting the secondly added result to each of the asset values balanced for the investment target assets at a previous time point.

The coefficient tuner 170 is configured to firstly tune the proportional control coefficient, integral control coefficient, derivative control coefficient, or the combinations thereof through a result interpretation and sensitivity analysis on the balanced asset values. And the coefficient tuner 170 is further configured secondly tune to the feedforward control coefficient according to a hypothetical return ratio distribution estimated for each of the investment target assets. The firstly tuning includes tuning the proportional control coefficient, integral control coefficient, derivative control coefficient, or the combinations thereof, so that the error within a predetermined range and the asset values are balanced and output within a predetermined time duration through the result interpretation and sensitivity analysis on the balanced asset values. The secondly tuning includes: tuning the feedforward control coefficient by calculating a ratio between the target return ratio set according to the investment preferences of the investor and the estimated return ratio according to the hypothetical return ratio distribution

Since the balancing of the asset values and the tuning of the coefficients are explained with reference to FIG. 2 and FIG. 3, they are omitted herein.

The asset allocation ratio adjuster 150 is configured to adjust an asset allocation ratio by allocating assets for each investment target asset based on each of the balanced asset values.

Since the adjusting of the asset allocation ratio is explained with reference to FIG. 3, the detailed description of the adjusting of the asset allocation ratio is omitted herein.

The asset allocation ratio transmitter 160 is configured to transmit the adjusted asset allocation ratio to the investor terminal 200 to propose the adjusted asset allocation ratio to the investor.

The investor manager 180 is configured to store and manage investor information (such as identifiers, passwords, etc.), the balanced asset values, the proposed asset allocation ratios, and other relevant data by each investor using the asset allocation ratio adjusting system 100 of the present invention.

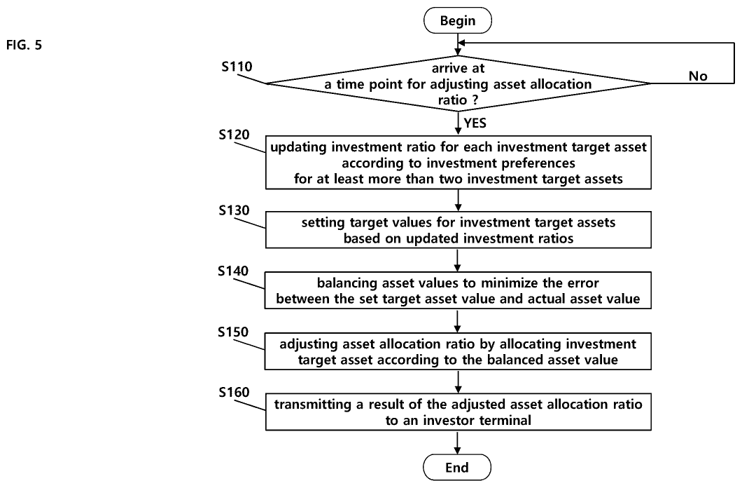

FIG. 5 is a flowchart illustrating a procedure for balancing an asset allocation ratio according to an embodiment of the present invention.

As shown in FIG. 5, the procedure for adjusting the asset allocation ratio according to one embodiment of the present invention comprises in the asset allocation ratio adjusting system 100 checking whether the time point for adjusting an asset allocation ratio arrives, S110. When the asset allocation adjustment time point arrives, an investment ratio is updated by reflecting investment preferences of the investor for at least two or more investment target assets in the asset allocation ratio adjusting system 100, S120.

The investment ratio is updated based on the investment ratio which the investor input for each of the investment target assets in advance, and updated by investment preferences of the investor for each of the investment target assets.

The investment ratio is inputted through the investment ratio input component 110 by the investor for at least two or more investment target assets, and investment preferences are inputted through the investment preference input component 120 by the investor for each investment target asset.

The investment ratio and investment preferences can be updated by the investor, and the asset allocation ratio adjusting system 100 is configured to retain and use the previously inputted investment ratio and investment preferences, if the investment ratio and the target asset values are not changed.

Next, the asset allocation ratio adjusting system 100 is configured to set the target asset values according to the updated investment ratio, S130.

Each of the target asset values is set according to the updated investment ratio.

Next, the asset allocation ratio adjusting system 100 is configured to balance the asset values to minimize the error between the set target asset value and the asset value, S140.

That is, the asset allocation ratio adjusting system 100 is configured to balance the asset values according to [Equation 1], and further includes firstly tuning the proportional control coefficient, integral control coefficient, differential control coefficient or the combinations thereof, with a feedback of the asset values, to minimize the error, secondly tuning the feedforward control coefficient by using a hypothetical return ratio distribution, or the combination thereof.

Since the tuning is explained with reference to FIG. 4, a more detailed explanation is omitted herein.

Next, the asset allocation ratio adjusting system 100 is configured to adjust an asset allocation ratio, S150, by allocating each of the investment target assets according to the balanced asset values, thereby adjusting the asset allocation ratio.

That is, the asset allocation ratio is adjusted according to the investment preferences of the investor by increasing or decreasing the allocation amount of the investment target assets based on the actual asset value of each investment target asset and the balanced each asset value.

Since the adjusting of the asset allocation ratio is explained in detail with reference to FIG. 4, the detailed description of the adjusting is omitted herein.

Next, the asset allocation ratio adjusting system 100 is configured to transmit the result of the adjusted asset allocation ratio to the investor terminal 200, S160, thereby proposing the adjusted asset allocation ratio to the investor.

Subsequently, the investor can invest (buy) new funds in each investment target asset or liquidate (sell) a part of each investment target asset, by using the proposed asset allocation ratio (i.e., the adjusted asset allocation ratio) received from the asset allocation ratio adjusting system 100, thereby enabling the asset allocation ratio to be adjusted.

Meanwhile, the adjusting of the asset allocation ratio through the above procedures can be performed for the entire sector based on the settings of the investor, for at least two or more sectors, or for the individual assets that make up each sector.

Each of the individual assets refers to, for example, a stock of a specific corporation listed in a corresponding market.

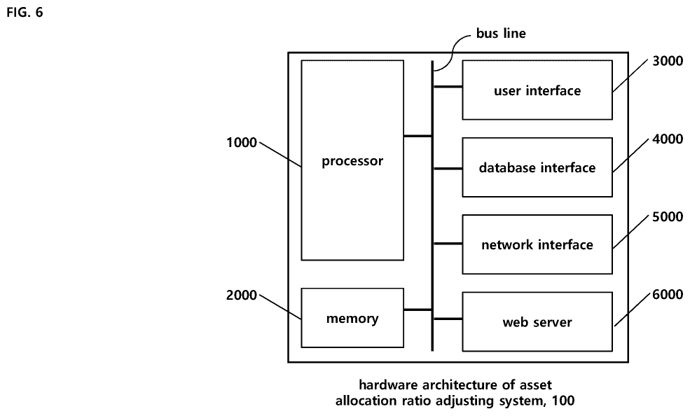

FIG. 6 is a diagram illustrating a hardware architecture of a system for adjusting an asset allocation ratio according to an embodiment of the present invention.

As shown in FIG. 6, the hardware structure of the asset allocation ratio adjusting system 100 according to one embodiment of the present invention includes a processor 1000, a memory 2000, a user interface 3000, a database interface 4000, a network interface 5000, and a web server 6000.

The memory 2000 is configured to store a program that executes a method for adjusting the asset allocation ratio, and the processor 1000 is configured to load and execute the program stored in the memory 2000 to propose the asset allocation ratio to be adjusted by the investor.

The user interface 3000 is configured to provide an input and output interface to the investor using a graphical user interface (GUI, graphical user interface) needed to implement the investment ratio input component 110 and the investment preference input component 120, while the database interface 4000 is configured to provide an interface between the database 400 and the hardware structured in FIG. 6.

The network interface 5000 is configured to provide the means for the investor to access the asset allocation ratio adjusting system 100 through the investor terminal 200. Most investors can remotely connect to the web server 6000 to access the asset allocation ratio adjusting system 100.

Each of the aforementioned configuration or method is implemented as computer-readable code (program) on a computer-readable recording medium (i.e., memory) or as computer-readable code (program) transmitted through a transmission medium. The computer-readable recording medium (i.e., memory) is a data storage device that can store data that can be read by a computer system.

Examples of computer-readable recording media include databases, ROM, RAM, CD-ROM, DVD, magnetic tapes, floppy disks, optical data storage devices, or semiconductor chip, but are not limited to the above listed media. The transmission medium includes carrier waves transmitted through the Internet or various types of communication channels. Additionally, the computer-readable recording medium stores computer-readable code in a distributed manner, which is distributed and executed through a networked computer system.

Furthermore, at least more than one component applied in the present invention include a processor 1000 that performs each function of the components or is implemented by the processor 1000, and two or more of the components can be combined into a single component to perform all operations or functions for the combined components.

As described above, the present invention has the effect of increasing the long-term returns or reducing investment risks of the investor by periodically proposing to adjust the asset allocation ratio to the investor. Additionally, the present invention has the effect of allowing a portfolio to be constructed according to the investment preferences of the investor, by updating investment ratio based on the preferences of the investor, setting target asset values, balancing the asset values, and adjusting the asset allocation ratio to minimize the difference between the set target asset values and the balanced asset values.

As mentioned above, the present disclosure has been explained with reference to the embodiments shown in the drawings, but this is merely illustrative embodiments, and one skilled in the art will understand that various modifications and equivalent alternative embodiments are possible. Therefore, the technical scope of the present invention should be determined by the following claims.

The reference numerals in the drawings are indicated as 100 is a system for adjusting asset allocation ratio, 110 is an investment ratio input component, 120 is an investment preference input component, 130 is an investment ratio updater, 140 is an asset value balancer, 150 is an asset allocation ratio adjuster, 160 is an asset allocation ratio transmitter, 170 is a coefficient tuner, and 180 is an investor manager.

What is claimed is:

1. A system for adjusting an asset allocation ratio, comprising a memory configured to store a program code for adjusting the asset allocation ratio and a processor configured to load and execute the program stored in the memory, wherein the processor is configured to:
update investment ratio for at least two or more investment target assets invested by an investor, at a predetermined time point when the asset allocation ratio is adjusted for the investor;
set target asset values for asset values of the investment target assets based on the updated investment ratio;
balance the asset values of the investment target assets according to the updated investment ratio, to minimize an error between each of the set target asset values and each of the asset values of the investment target assets; and
adjust the asset allocation ratio by allocating the investment target assets according to the balanced asset values,
wherein the investment ratio are updated by reflecting the investment preferences of the investor.

2. The system of claim 1, wherein the updating of the investment ratio includes maintaining the investment ratio previously input by the investor according to the investment preferences for each of the investment target assets, or increasing or decreasing each of the previously input investment ratio with a predetermined ratio, and
wherein the investment preferences include recovery of asset value, receipt of fixed income, receipt of high return, long-term investment, or the combinations thereof.

3. The system of claim 1, wherein the setting of the target asset values includes setting each of the target asset values for asset values of the investment target assets according to the updated investment ratio for asset values of all investment target assets at the predetermined time point.

4. The system of claim 1, wherein the balancing of the asset values includes firstly adding a result of multiplying an error between each of the set target asset values and each of the asset values of the investment target assets by a predetermined proportional control coefficient, a result of multiplying a result of integrating the error over a predetermined period by a predetermined integral control coefficient, a result of multiplying a result of the derivative of the error over the predetermined period by a predetermined derivative control coefficient, or a combination thereof, and then reflecting the firstly added result to each of the asset values balanced for the investment target assets at a previous time point.

5. The system of claim 4, wherein the balancing of the asset values further includes: secondly adding a result of multiplying each of the set target asset values by a predetermined feedforward control coefficient to the firstly added result, and then reflecting the secondly added result to each of the asset values balanced for the investment target assets at a previous time point.

6. The system of claim 4, wherein the adjusting of the asset allocation ratio includes firstly tuning the proportional control coefficient, integral control coefficient, derivative control coefficient, or the combinations thereof through a result interpretation and sensitivity analysis on the balanced asset values.

7. The system of claim 5, wherein the adjusting of the asset allocation ratio includes secondly tuning the feedforward control coefficient according to a hypothetical return ratio distribution estimated for each of the investment target assets.

8. The system of claim 6, wherein the firstly tuning includes: tuning the proportional control coefficient, integral control coefficient, derivative control coefficient, or the combinations thereof, so that the error within a predetermined range and the asset values are balanced and output within a predetermined time duration through the result interpretation and sensitivity analysis on the balanced asset values.

9. The system of claim 7, wherein the secondly tuning includes: tuning the feedforward control coefficient by calculating a ratio between the target return ratio set according to the investment preferences of the investor and the estimated return ratio according to the hypothetical return ratio distribution.

10. The system of claim 2, wherein the updating of the investment ratio includes: adding a predetermined rate for annual return ratio of a corresponding investment target asset to each of the previously updated investment ratio, when one of the investment preferences of the investor is the long-term investment.

11. The system of claim 1, wherein the investment target assets are configured to be multiple sectors, each sector includes domestic stocks, foreign stocks, exchange-traded funds, exchange-traded notes, bonds, commodities, real estate, or the combinations thereof, and the asset allocation ratio is adjusted for all sectors, for at least two or more sectors, or for an individual investment target asset that makes up each sector, according to the settings of the investor.

12. A method for adjusting an asset allocation ratio, comprising:
in a system for adjusting the asset allocation ratio, updating investment ratio for at least two or more investment target assets invested by an investor, at a predetermined time point when the asset allocation ratio is adjusted for the investor;
in the system for adjusting the asset allocation ratio, setting target asset values for asset values of the investment target assets based on the updated investment ratio;
in the system for adjusting the asset allocation ratio, balancing the asset values of the investment target assets according to the updated investment ratio, to minimize an error between each of the set target asset values and each of the asset values of the investment target assets; and
in the system for adjusting the asset allocation ratio, adjusting the asset allocation ratio by allocating the investment target assets according to the balanced asset values,
wherein the investment ratio are updated by reflecting the investment preferences of the investor.
